(19) United States
(12) Patent Application Publication
(10) Pub. No.: US 2008/0231006 A1
(43) Pub. Date: Sep. 25, 2008

(54) Inter-Convertible Single Person Type Transporting Aid

(76) Inventor: Adriaan Van Eeden, Pretoria (ZA)

Correspondence Address: WYATT, TARRANT & COMBS, LLP, 1715 AARON BRENNER DRIVE, SUITE 800, MEMPHIS, TN, 38120-4367, US

(21) Appl. No.: 10/574,037

(22) PCT Filed: Sep. 20, 2004
(86) PCT No.: PCT/ZA04/00111

§ 371 Date: Jun. 8, 2007

(30) Foreign Application Priority Data
Sep. 26, 2003 (ZA) 03/7484

(51) Int. Cl. A61G 5/04; A61H 3/04

(52) U.S. Cl. 280/7.15; 280/250.1; 180/6.5; 180/65.5

(57) ABSTRACT

An inter-convertible single person type transporting aid (10) comprises a multi directionally propellable wheeled carrier frame (12) that is fitted with drive wheels (14) that are independently drivable via motors (16) and situated to enable aid central axis turning. The frame (12) is constituted from an upper frame part (20) displaceably mounted to a wheeled base frame (22) fitted at its outer corners with castors (24). The upper frame part (20) is biased in the direction of arrow (30) relative to the base frame (22). The aid (10) is re-arrangeable into a walk supporter or walker (38), a sitting transporter and a standing transporter by the removable fitting of a seat and a standing platform respectively.

### BACKGROUND TO THE INVENTION

Single person type transporting equipment and aids are often found in the health impaired environment or for use by the aged. Typically are a wheel chair and a walker. Normally such equipment serves a single purpose only. With the increased cost of transportation and congestion the availability of economical single person transportation is becoming increasingly more important for general use as well. While conditions of general use do not require the ability to do tight turns, specialised single person transporting equipment used indoors often requires such ability. The availability of inter-convertible transportation equipment serving both a general and specialised purpose while accommodating particular circumstances is consequently of substantial importance.

### FIELD OF THE INVENTION

This invention relates to an inter-convertible single person type transporting aid employable for everyday use as well as in a specialised environment such as under conditions of health impairment.

### PRIOR ART DESCRIPTION

Single person type transportation equipment is mainly found in the environment of health impaired or aged person use. Specialised single person transporting equipment being able to serve a number of purposes is found in the prior art. U.S. Pat. No. 6,378,883 shows a motorised walker that can also be used as wheel chair type equipment. Its use as a walker does not incorporate the standard semi enclosing frame which accommodates the ease of use of such equipment. While it is formed with wheels at outside positions this walker will not be able to perform tight turns such as in a corridor of a hospital or a home for the aged. U.S. Pat. No. 6,460,641 shows a motorised wheel chair with drive intermediate its outside wheels apparently enabling its performing tight turns. The equipment of this invention is however not inter-convertible to enable its performing a variety of other single person transporting functions.

### BRIEF DESCRIPTION OF THE DRAWING

The invention is now described, by way of example, with reference to the accompanying drawings. In the drawings

FIG. 1 shows an inter-convertible single person type transporting aid, according to the invention, convertible between a walk support providing condition, a sitting transporter providing condition and a standing transporter providing condition in a drive wheel non-engaging side elevational walk support providing condition,

FIG. 2 shows the aid in its drive wheel engaging side elevational walk support providing condition,

FIG. 3 shows the aid in its plan view support providing condition,

FIG. 4 shows the aid in direction of arrow A in FIG. 1,

FIG. 5 shows the aid in the direction of arrow B in FIG. 1,

FIG. 6 shows the aid in its side elevational sitting transporter providing condition,

FIG. 7 shows the aid in plan view in its sitting transporter providing condition,

FIG. 8 shows the aid in the direction of arrow C in FIG. 6,

FIG. 9 shows the aid in the direction of arrow D in FIG. 6,

FIG. 10 shows the aid in its side elevational standing transporter providing condition,

FIG. 11 shows the aid in plan view in its standing transporter providing condition,

FIG. 12 shows the aid in the direction of arrow E in FIG. 10, and

FIG. 13 shows the aid in the direction of arrow F in FIG. 10.

### DETAILED DESCRIPTION OF THE DRAWINGS

Referring to the drawings an inter-convertible single person type transporting aid employable as walk supporter, sitting transporter and standing transporter in response to appropriate conversion or re-arrangement is generally indicated by reference numeral 10.

The aid 10 comprises a multi directionally propellable wheeled carrier facility in the form of a carrier frame 12 that is fitted with a drive wheel arrangement in to form of laterally situated drive wheels 14 that are drivable by powerable propulsion means in the form of battery driven motors 16 powered from batteries held by battery holders 18. The frame 12 is constituted from a drive wheel carrying user accommodating part in the form of an upper frame part 20 displaceably mounted to a wheeled base frame 22 fitted at its outer corners with castors 24.

The upper frame part 20 is so displaceably mounted by way of drive wheel carrying arms 26 that fit displaceably along sleeves 28 while being biased in the direction of arrow 30 relative to the base frame 22 by way of a spring (not shown) covered by spring covers 32. The wheels 14 are secured to the lower ends of the arms 26 respectively and are urged out of rolling base engaging contact by the springs except when the frame part 20 is exposed to a downward exerted force, as discussed below.

The drive wheels 14 are situated laterally of the central axis 34 of the aid 10 in a plane that extents through the axis 34 and generally centrally through the aid 10. The drive wheels 14 are also independently drivable in both directions by means of their motors 16. Running of the motors 16 are controlled by means of a conventional multi directional controller 36 mounted on the upper frame part 20. Being so drivable in opposite directions enables the aid 10 to be turned about the axis 34 having the result that when the aid is converted to a sitting transporter performing condition or a standing transporter performing condition, both as discussed in more detail below, the aid 10 can turn on the spot where it stands by driving the wheels 14 in their opposite directions.

Although not shown, when the drive wheels 14 are inherently non-suspensive they can be mounted on sprung pivotal arms rendering the upper frame part 20 suspensive. The drive wheels 14 are mounted to only rotate when their drive motors 16 are powered. When not so powered the wheels 14 are restrained against rotation thus serving a rolling base engaging braking function when urged into abutment with such base.

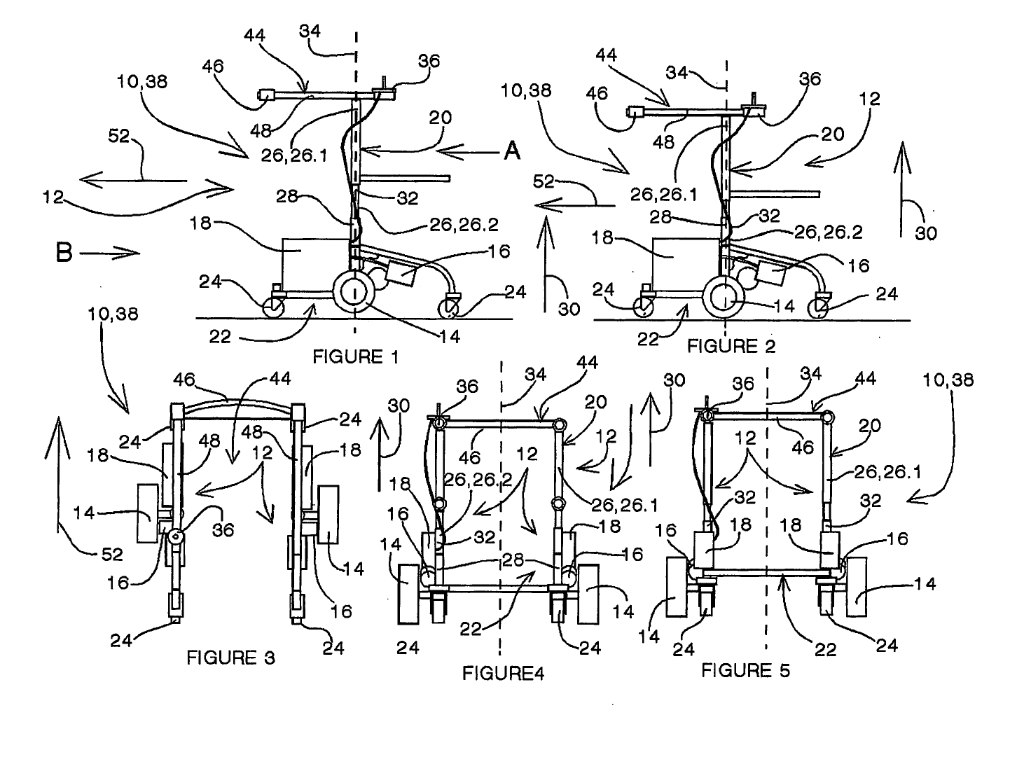

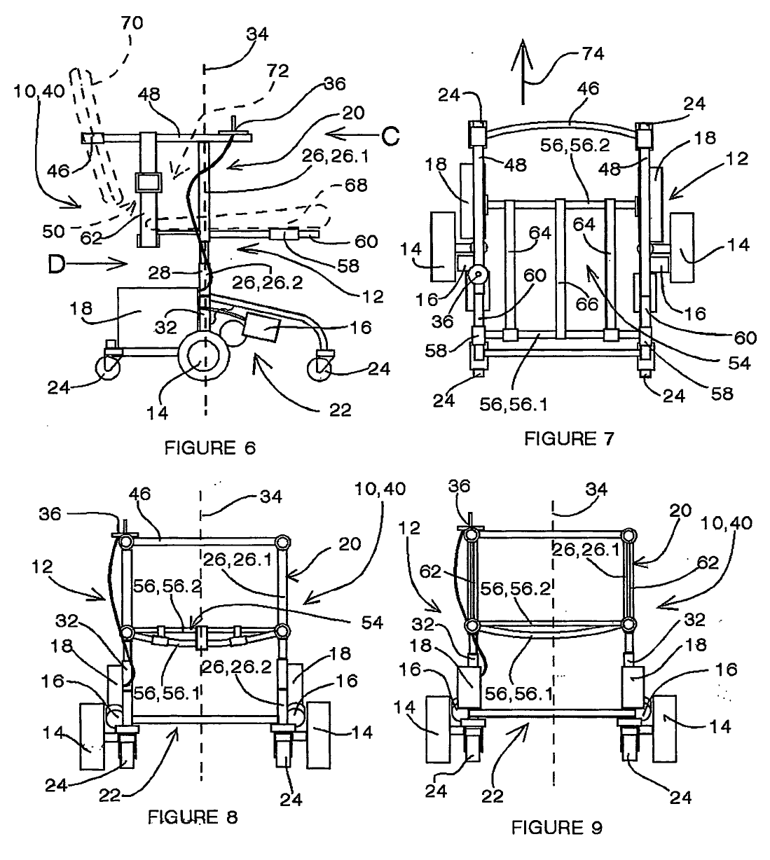

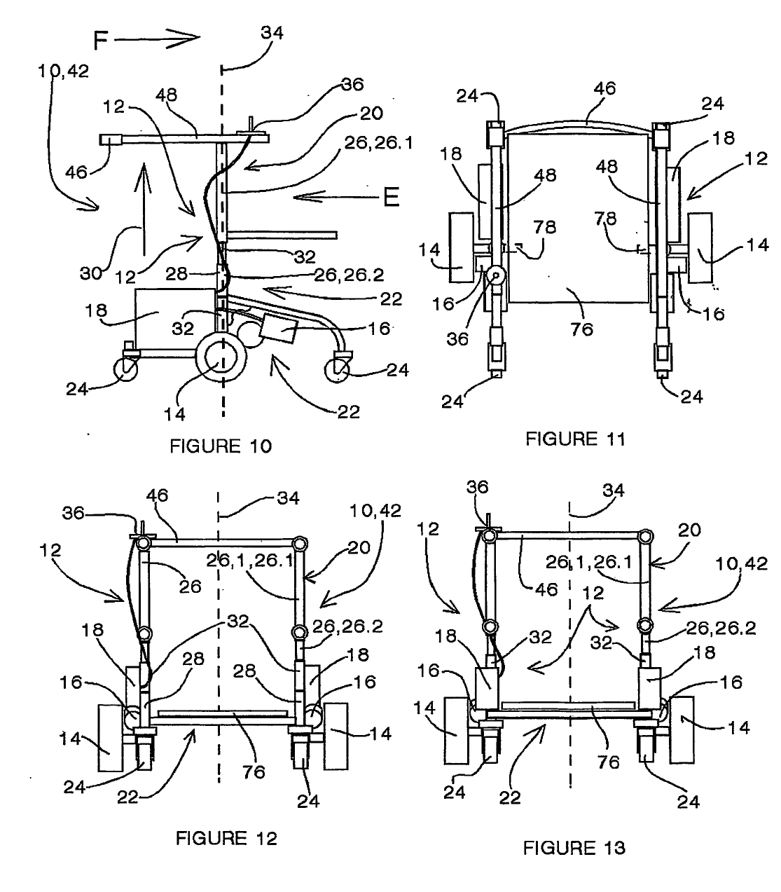

The aid 10 is thus inter-convertible between a walk supporter or walker 38, as discussed further on with reference to FIGS. 1 to 5, and a sitting transporter 40 as discussed further on with reference to FIG. 6 to 9 and a standing transporter 42 as discussed further on with reference to FIG. 10 to 13.

Referring to FIGS. 1 to 5 the upper frame part 20 of the aid 10 presents a semi enclosing frame 44 defined by a transverse gripping handle providing frame member in the form of a gripping handle 46 extending into user accommodating part laterally situated semi loop formation contributing arms 48 integrally incorporated into the upper frame part 20 within which frame 44 a user is situated once using the aid 10 as walker. When the aid 10 has been used as a sitting transporter 40 or standing transporter 42 prior to conversion to a walker 38, the wheeled base frame 22 extends substantially rectangular when viewed in plan view.

Once so converted the aid 10 is in its conventional walker providing form, movement of which during use takes place in generally the direction of arrow 52.

When used as walker 38 the aid 10 is only used to assist the walker user in the conventional walking action resulting in only a small downward urging being exerted on the upper frame part 20 in response to the manual gripping of the semi enclosing frame 44. The biasing springs biasing the upper frame part 20 away from the base frame 22 are selected to maintain their biasing action except when exposed to a substantial downward force that is at any rate larger that the force so exerted on the upper frame part 20 when the aid 10 is conventionally used as walker. In consequence and as shown in FIG. 1 the drive wheels 14 are maintained out of rolling base engaging contact by the springs when the aid 10 is so conventionally walker fashion used with aid motion being promoted via the castors 24. Should a user however require the exertion of a braking effect on the walker 38 during use and referring to FIG. 2, an increased downward force is simply exerted on the upper frame part 20 via the semi enclosing frame to the extent of overcoming the bias of the springs thus causing the drive wheels 14 to come into rolling base abutment. As the wheels 14 when not driven by their motors 16, are restrained from rotation, their urging against the rolling base once the aid 10 is walker fashion used has the effect of braking the progress of the walker 38 thus aiding in controlling its motion.

When in its walker providing condition the aid 10 is easily collapsible to promote its ease of transportation. To this end the gripping handle 46 engages releasably with the arms 48. Each of the drive wheel carrying arms 26 is constituted from an upper section 26.1 and a lower section 26.2. The upper sections 26.1, as forming part of the upper frame part 20, engage bayonet fashion with the lower sections 26.2, as forming part of the base frame 22. The upper sections 26.1 include the springs as covered by the covers 32. They thus engage releasably with the bottom sections 26.2 just below the springs. The upper and lower sections 26.1, 26.2 are maintained locked to one another by the locking action of the handle 46. To collapse the aid 10 the handle 46 is simply removed freeing the upper and lower frame sections 26.1 and 26.2 to be bayonet coupling fashion uncoupled having the effect of separating the upper frame part 20 (though with the handle removed) from the base frame 22.

Conversion of the aid 10 from its walker providing condition to its sitting transporter providing condition, while also referring to FIGS. 6 to 9, involves the use of the seat arrangement 50. This thus comprises the securing of a seat base support grid 54 to the upper frame part 20. The grid 54 is constituted from opposing end bars 56 of which the one bar 56.1 is slidably engaged via end sockets 58 with seat forming arms 60 integrally forming part of the upper frame part 20 while the opposite bar 56.2 is suspended from the semi loop formation contributing arms 48 via slings 62. The grid 54 is formed by the securing of grid connectors 64 to extend between the opposing bars 56. As further support one or more support straps 66 are slung to extend between the opposing bars 56. A seat base 68 is thus secured to the grid 54. A seat backrest 70 is furthermore secured to the gripping handle 46. The seat base 68 s and backrest 70 together define the seat 72 of the sitting transporter 40. As an alternative although not shown the seating portion of the seating arrangement 50 can be swivellably secured via its trailing axis to the upper frame part 20 causing it to form an integral part of the carrier frame 12.

The direction of forward travelling of the aid 10 when converted to the sitting transporter 40 is in the direction of arrow 74 and thus opposite to that of the aid 10 when converted to the walker 38. Owing to the drive wheels 14 being drivable in both directions the sifting transporter 40 can naturally be driven in both directions. The biasing effect of the springs are selected to result in the upper frame part 20 being urged downward once the seat 72 is occupied resulting in the drive wheels 14 coming into sitting transporter driving contact with a rolling base.

Conversion of the aid 10 from its walker providing condition to its standing transporter providing condition, as shown in FIGS. 10 to 13, is achieved by simply fitting a standing base 76 to the base frame 22, while naturally requiring removal of the seating arrangement 50 when conversion is from the sitting transporter providing condition or swivelling the seat of the arrangement 50 upward and removing the backrest portion. To ensure that the effect of drive wheel to rolling base engagement can be achieved in this case the lower ends of the arms 26 are formed with inwardly projecting lugs 78 facing into the intermediate zone of the base frame 22. Operative fitting of the standing base 76 thus also involves its edgewise location onto the lugs 78 in addition to resting on either the front or rear cross arms of the frame 22. Once a user is positioned on the standing base 76 the downward force of the user's weight causes the downward urging of the upper frame part 20 resulting in drive wheel to rolling base engagement for riding the aid 10 in a standing condition.

As the aid 10 is constituted of several removably mountable parts the invention also relates to a set constituted from the carrier frame 12, as separable into an upper frame part 20 and a base 22, the seating arrangement 50 or at least its backrest 70 and the standing base 76.

The aid 10 provides the advantage that a multi-purpose single person type transporter is provided that can be used for both general and specialised purposes.

1-24. (canceled)

25. An inter-convertible single person type transporting aid (10) comprising
a multi directionally propellable wheeled carrier facility (12) that is fitted with user controllable, powerable propulsion means (16) arranged to drive the aid (10) via a drive wheel arrangement (14) and which aid (10) is formable by a user into a variety of conditions of use
characterised in that
the aid (10) is without at least substantial external aid if at all inter-convertible between at least two of
a walk support providing condition in which it, in serving as walk supporter (38), provides for a user to be positioned within a conventionally walker fashion extending semi enclosing frame (44) forming part of the facility (12) in the appropriate case involving the latter's suitable re-adjustment,
a sitting transporter type condition in which it serves as a sitting transporter (40) on appropriate manipulation relative to if not fitting of at least part of a seat arrangement (50) to the carrier facility (12) in the appropriate case also involving the latter's suitable re-adjustment, and
a standing transporter providing condition in which it serves as a standing transporter (42) as brought about by the appropriate removable positioning of a standing base (76) relative to the carrier facility (12) including the use of the semi enclosing frame (44) with the propulsion means (16) being arranged to at least be employable for propelling the aid when in its sitting or standing transporter providing condition to whichever condition the aid (10) is convertible if not to both,
and in that
the carrier facility (12) incorporates a drive wheel arrangement carrying user accommodating part (20) of which the semi-enclosed frame (44) forms part and that is arranged to at least one of holding the seat arrangement (50) when the aid is in its sitting transporter providing condition and at least partly serving for mounting the standing base (76) once the aid (10) is inter-converted into its standing transporter providing condition, to at least one of whichever conditions the aid is inter-convertible into, while the user accommodating part (20) is used as such once the facility (12) is converted into its walk support providing condition if thus inter-convertible, and
a wheeled base frame (22), to which the user accommodating part (20) is displaceably mounted while being biased by biasing means relative to the base frame (22) to a condition of drive wheel arrangement disengagement from a rolling base onto which the aid is situated once in use thereby enabling the powerable propulsion of the aid when in its appropriate condition, once the user accommodating part (20) is exposed to a downward exerted force as brought about at least once the aid (10), as appropriately converted, is occupied owing to causing the drive wheel arrangement (14) to come into rolling engagement with such rolling base.

26. A transporting aid as claimed in claim 25 in which the drive wheel arrangement (14) is constrainable against rolling for serving a braking effect against free rolling of the aid (10) to whichever condition it is inter-converted thereby also enabling the controlling of the free rolling motion of the aid (10) once in its walk support providing condition, when so inter-convertible, as brought about by the urging of the drive wheel arrangement (14) by a user, once constrained against free rolling, to come into braking contact with a rolling base in response to the manual exertion of a downward force on the user accommodating part via the semi enclosing frame (44).

27. A transporting aid as claimed in claim 25 in which the drive wheel arrangement (14) is in the form of laterally spaced independently to and fro drivable drive wheels as mounted to the user accommodating part (20) that are suitably positioned relative to the remainder of the carrier facility (12) to also enable rotation of the aid (10), at least when in its sitting transporter or standing transporter providing condition, into at least one of whichever conditions the carrier facility (12) is convertible, about a substantially centrally extending upright axis (34).

28. A transporting aid as claimed in claim 27 in which the user accommodating part (20) engages with the wheeled base frame (22) via laterally extending drive wheel carrying arms (26) that each passes snugly displaceably along base frame presented sleeves (28) and to the bottom ends of which arms (26) the drive wheels (14) are respectively mounted.

29. A transporting aid as claimed in claim 27 in which the aid is multi-directionally propellable via castor wheels (26) at least one of each being positioned at the outer corners of the wheeled base frame (22) as correspondingly formed, the drive wheels (14) thus being situated intermediate front and rear castor wheels (26) found along each side of the wheeled base frame (22).

30. A transporting aid as claimed in claim 25 in which the semi-enclosing frame (44) is in the form of a transverse gripping handle providing frame member (46) extending into upper end arms (48) integrally incorporated in the user accommodating part (20), the gripping handle providing frame member (46) also being employed for securing a backrest portion (70) of the seat arrangement (50) once the aid is in its sitting transporter providing condition, in the case of being so inter-convertible.

31. A transporting aid as claimed in claim 25 in which in the case of the carrier facility (12) being appropriately inter-convertible, the seat arrangement (50) includes a support grid (54) supporting a seat base (68) with the seat arrangement (50) being releasably secured to the user accommodating part (20) once the aid is in its sitting transporter providing condition, removal of the support grid (54) and seat base (68) and in the appropriate case further re-adjustment of the carrier facility (12) thus enabling access of a user to the semi enclosing frame (44) for using the aid as the walk supporter (38) or as a standing transporter (42), into whichever condition the aid is inter-convertible if not to both.

32. A transporting aid as claimed in claim 25 in which aid (10) is inter-convertible, and the seat arrangement (50) includes a seat base (68) that is swivellably secured to the user accommodating part (20) thus being displaceable between a seat base providing condition and a stored condition.

33. A transporting aid as claimed in claim 25 in which in the carrier facility (12) is inter-convertible, and the standing base (76), as involved in its inter-conversion into the standing transporter (42), is formed to extend at least partly intermediate the base frame (22) while at least engaging with supports forming part of the user accommodating part (20) to cause its downward urging into drive wheel to rolling base engagement once the aid (10), as inter-converted for use as a standing transporter, is occupied.

34. A transporting aid as claimed in claim 25 in which the aid is in its sitting transporter providing condition, and is thus formable into, on the one hand, its walk support or its standing transporter providing conditions, into at least one of whichever conditions the facility (12) is convertible into, on the other hand, to face in opposite directions.

35. A transporting aid as claimed in claim 25 in which the user accommodating part (20) engages releasably with the wheeled base frame (22) enabling the collapsing of the carrier facility (12) and thus the transporting aid (10).

36. A transporting aid as claimed in claim 25 in which the carrier facility (12) is comprised to be formed into the walk supporter (38), the sitting transporter (40) and the standing transporter (42), in the latter two cases requiring relevant supplementation.

37. An inter-convertible single person type transporting aid set assemblable into a single person type transporting aid (10) that is inter-convertible into at least two of a walk support providing condition, a sitting transporter type condition and a standing transporter providing condition comprising
a user accommodating part (20) incorporating a semi-enclosed frame (44) and which part (20) at least provides for being fitted with a drive wheel arrangement (14) if not incorporating such thus forming a drive wheel arrangement carrying user accommodating part while further being arranged to at least one of holding a suitable seat arrangement when such aid (10), once assembled from the set, is in its sitting transporter providing condition and at least partly serving for mounting a suitable standing base once such aid (10), as so assembled, is inter-converted into its standing transporter providing condition, to at least one of whichever conditions it is inter-convertible to while the user accommodating part (20) is used as such if such aid (10) as thus assembled, is converted into its walk support providing condition, if thus inter-convertible,
a wheeled base frame (22), to which the user accommodating part (20) is displaceably mountable while, once so mounted thus forming a multi directionally propellable wheeled carrier facility (12), being biased by biasing means relative to the base frame (22) to a condition of drive wheel arrangement disengagement from a rolling base onto which such aid (10) as thus assembled, is situated once in use,
user controllable, powerable propulsion means (16) suitably securable to one of the user accommodating part (20) and the wheeled base frame (22) for use in driving the drive wheel arrangement (14) and thus such carrier facility (12) once appropriately assembled and converted, and
a drive wheel arrangement (14) if not already incorporated in the user accommodating part (20),
such aid (10), once assembled from the set, thus being inter-convertible into serving at least two of a walk supporter (38), providing for a user to be positioned within the conventionally walker fashion extending semi enclosing frame (44) forming part of the user accommodating part (20), a sitting transporter (40), requiring appropriate manipulation relative to if not fitting of at least part of such seat arrangement to such carrier facility (12), once assembled from the user accommodating part (20) and the wheeled base frame (22), and a standing transporter (42), requiring the appropriate removable positioning of such standing base (76) relative to such carrier facility (12).

38. A transporting aid set as claimed in claim 37 in which the drive wheel arrangement (14) is constrainable against rotation for serving a braking effect against free rolling of an aid (10) once assembled from the set, to whichever condition it is inter-converted thereby also enabling the controlling of its free rolling motion once in its walk support providing condition, when so inter-convertible, as brought about by the urging of the drive wheel arrangement (14) by a user, once constrained against free rolling, to come into braking contact with a rolling base in response to the manual exertion of a downward force on the user accommodating part via the semi enclosing frame (44).

39. A transporting aid set as claimed in claim 39 in which the drive wheel arrangement (14) is in the form of laterally spaced independently to and fro drivable drive wheels that are mounted to the user accommodating part (20) and that are suitably positioned relative to the remainder of a carrier facility (12) once an aid (10) is assembled from the set, to also enable the rotation of such aid (10) as thus assembled, at least when in its sitting transporter or standing transporter providing condition, into the at least one of whichever conditions such carrier facility (12) is convertible once assembled from the user accommodating part (20) and the wheeled base frame (22), about a substantially centrally extending upright axis (34).

40. A transporting aid set as claimed in claim 39 in which the user accommodating part (20) is engageable with the wheeled base frame (22) via laterally extending drive wheel carrying arms (26) that is each formed to snugly though displaceably pass along base frame presented sleeves (28) and to the bottom ends of which arms (26) the drive wheels (14) are respectively mounted during assembling of the set.

41. A transporting aid set as claimed in claim 37 in which the wheeled base frame (22) is multi-directionally propellable via castor wheels (26) at least one of each being positioned at its outer corners as correspondingly formed, the drive wheels (14), once the set is assembled into an aid (10), thus being situated intermediate front and rear castor wheels (26) found along each side of the wheeled base frame (22).

42. A transporting aid set as claimed in claim 37 in which the semi-enclosing frame (44) is in the form of a transverse gripping handle providing frame member (46) extending into upper end arms (48) integrally incorporated in the user accommodating part (20), the gripping handle providing frame member (46) also being employed for securing a backrest portion of a suitable seat arrangement once an aid (10), as assembled from the set, is in its sitting transporter providing condition, in the case of being so inter-convertible.

43. A transporting aid set as claimed in claim 37 in which aid (10) includes at least one of a seat arrangement (50) and a standing base (76) depending into whichever one of the walk support providing condition and the sitting transporter type condition such aid (10) once assembled from the set is inter-convertible into, if not into both.

44. A transporting aid set as claimed in claim 43 in which in the case of an aid (10) as assembled from the set is appropriately inter-convertible, the seat arrangement (50) includes a support grid (54) supporting a seat base (68) with the seat arrangement (50) being releasably secured to the user accommodating part (20) once such aid (10), as thus assembled, is in its sitting transporter providing condition, removal of the support grid (54) and seat base (68) and in the appropriate case further re-adjustment enabling access of a user to the semi enclosing frame (44) for using such aid (10), as thus assembled, as a walk supporter (38) or as a standing transporter (42), into whichever condition it is inter-convertible into if not to both.

45. A transporting aid set as claimed in claim 43 in which in the case of an aid (10) once assembled from the set is appropriately inter-convertible, the seat arrangement (50) includes a seat base (68) that is swivellably secured to the user accommodating part (20) thus being displaceable between a seat base providing condition and a stored condition.

46. A transporting aid set as claimed in claim 43 in which in the case of an aid (10) once assembled from the set, is appropriately inter-convertible, the standing base (76), as involved in inter-converting such aid (10) into a standing transporter (42) is formed to extend at least partly intermediate the base frame (22) while at least engaging with supports forming part of the user accommodating part (20) to cause its downward urging into drive wheel to rolling base engagement once such aid (10), as inter-converted for use as a standing transporter, is occupied.

47. A transporting aid set as claimed in claim 37 in which an aid (10) as thus assembled from the set, is arranged to cause its sitting transporter providing condition, as thus formable, on the one hand, and its walk support or its standing transporter providing conditions, into at least one of whichever conditions the facility (12) is convertible, on the other hand, to face in opposite directions.

48. A transporting aid set as claimed in any one of claims 37 in which the inter conversion an aid (10) is assembled into a walk supporter (38), a sitting transporter (40) and a standing transporter (42), in the appropriate case requiring relevant supplementation.
